(19) United States
(12) Patent Application Publication
(10) Pub. No.: US 2010/0163763 A1
(43) Pub. Date: Jul. 1, 2010

(54) PILOT OPERATED VACUUM PACKABLE INFLATION SYSTEM

(76) Inventor: Ronald F. BRADFORD, Oakdale, MN (US)

Correspondence Address: MCNEES WALLACE & NURICK LLC, 100 PINE STREET, P.O. BOX 1166, HARRISBURG, PA, 17108-1166, US

(21) Appl. No.: 12/647,886

(22) Filed: Dec. 28, 2009

Related U.S. Application Data
(60) Provisional application No. 61/141,809, filed on Dec. 31, 2008.

(51) Int. Cl. F16K 31/12

(52) U.S. Cl. 251/28

(57) ABSTRACT

An inflation system that is also used as a safety device to inflate a life-saving device such as a life raft. The inflation system may be manually activated or may be automatically activated as a result of contact with water. The system may include a gas-operated pilot valve having a self-contained small gas supply. The pilot valve is in fluid communication with a gas operated inflation valve. The gas-operated inflation valve includes a gas-actuated activator, an inlet in communication with a gas supply, an outlet and a fluid connection between the gas-operated pilot valve and the gas-actuated activator. The gas-actuated activator is movable from a first position that blocks fluid communication between the inlet and the outlet so as to prevent fluid flow between the inlet and the outlet, to a second position in which there is fluid communication between the inlet and the outlet. On activation, gas from the pilot valve activates a gas-actuated activator releasing a small self-contained gas supply in the pilot valve in response to the activation event, which in turn activates a gas-actuated activator in the gas-operated inflation valve, resulting in opening of the gas operated inflation valve and releasing gas from the gas supply to inflate the life raft.

### FIELD OF THE INVENTION

The present invention is directed to a self-inflating safety device, and more specifically, to a self-inflating life raft.

### BACKGROUND OF THE INVENTION

Inflating life-saving devices are utilized in emergency situations in water environments to provide floatation. Some equipment is activated upon ejection of the operator from the operator's vehicle. Other devices are inflated manually by the operator either prior to impacting the water or immediately after impact with the water. However, in certain cases, the operator may be incapacitated prior to or as a result of the ejection process from the vehicle, or as a result of impact with the water. In this circumstance, the operator may not be capable of manually activating the inflation device. There may be other circumstances that may prevent the operator from manually activating the inflation device, which could jeopardize the life or the operator or other personnel accompanying the operator, even though the floatation device remains fully operational.

### SUMMARY OF THE INVENTION

The present invention provides an inflation system that may be used as a safety device to inflate a life-saving device such as a life raft. The inflation system may be manually activated or may be automatically activated as a result of contact with water.

In one form, the system includes a gas-operated pilot valve. The gas-operated pilot valve includes a self-contained small gas supply. The pilot valve is in fluid communication with a gas operated inflation valve. The gas-operated inflation valve includes a gas-actuated activator, an inlet, an outlet and a fluid connection between the gas-operated pilot valve and the gas-actuated activator. The gas-actuated activator is movable from a first position that blocks fluid communication between the inlet and the outlet so as to prevent fluid flow between the inlet and the outlet, to a second position in which there is fluid communication between the inlet and the outlet. On activation, gas from the pilot valve moves the gas-actuated activator from the first position to the second position to open a passageway between the inlet and the outlet in the gas-operated inflation valve.

An activation mechanism releases the small self-contained gas supply in the pilot valve in response to an activation event. The released gas in the pilot valve, which is in fluid communication with the gas-operated inflation valve, activates the gas-actuated activator in the gas-operated inflation valve, causing the gas-actuated activator to move from the first position to the second position, thereby opening a passageway between the inlet and the outlet in the gas operated inflation valve.

In another embodiment, the system may also include a gas source, in fluid communication with the inlet of the gas operated inflation valve. Once the activation mechanism releases the small amount of self-contained gas in the pilot valve, which is in fluid communication with the gas-operated inflation valve, the gas activates the gas-actuated activator, moving it from the first position to the second position, opening or unblocking a passageway between the inlet and the outlet. Gas then flows from the gas source, through the inlet of the gas-operated inflation valve to the outlet of the gas-operated inflation valve. An inflatable life-saving device may be attached to the outlet of the inflation valve, so that the gas flowing through the outlet inflates the device.

The activation mechanism that releases the small self-contained gas supply in the pilot valve in the pilot valve is not restricted to any one mechanism, and may include a plurality of activation mechanisms. When one of the activation mechanisms includes a water activator, the system of the present invention will activate, resulting in inflation of the life-saving device when the water activator mechanism contacts water, if not already activated.

The present invention advantageously enables the inflation of a safety device upon contact with water, if not already activated. This ensures inflation of the safety device in the event that it is not otherwise activated by an operator.

The present invention also increases the size of the safety device that can be inflated as it provides a separate compressed gas source for inflation of a safety device, and a separate reduced compressed gas source to activate the activation mechanism for inflation.

Another advantage of the present invention is that after inflation of the safety device, the container for the gas source that provides gas for inflation of the safety device can remain attached to the safety device to provide additional buoyancy for the safety device.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 depicts an uninflated, self-inflating safety device of the present invention on a body of water.

FIG. 2 depicts a life raft contained within the self-inflating device of FIG. 1 inflating on the body of water.

FIG. 3 depicts the self-inflating device of FIG. 1 fully inflated on the body of water.

FIG. 4 depicts the self-inflating device of FIG. 1 in an uninflated condition, as it may be stored on a vehicle.

FIG. 5 depicts the inflation system of the present invention.

FIG. 6 is a detailed view of a first embodiment of a gas-operated inflation valve and gas-actuated activator.

FIG. 7 are views of optional gas-operated inflation valves that may be adapted for use in the present invention.

FIG. 8 is a view of a folded life raft prior to being vacuum packed in a frangible container, with pilot valve components separated from gas operated inflation valve attached to a gas source.

FIG. 9 is a detailed view of the gas-operated pilot valve with vacuum flange base and vacuum flange components.

FIG. 10 is top view of the vacuum flange components mounted to the gas-operated pilot valve without a vacuum bag.

FIG. 11 is a view of vacuum flange components ready for assembly to a vacuum bag.

FIG. 12 is a view of the vacuum packed inflatable packaged in a vacuum bag with the pilot valve mount extending from the vacuum bag.

FIG. 13 is a view of a fully inflated life raft with an attached gas source container and gas operated inflation valve.

FIG. 14 is a perspective view of the inflation system of the present invention attached to a gas source.

### DETAILED DESCRIPTION OF THE INVENTION

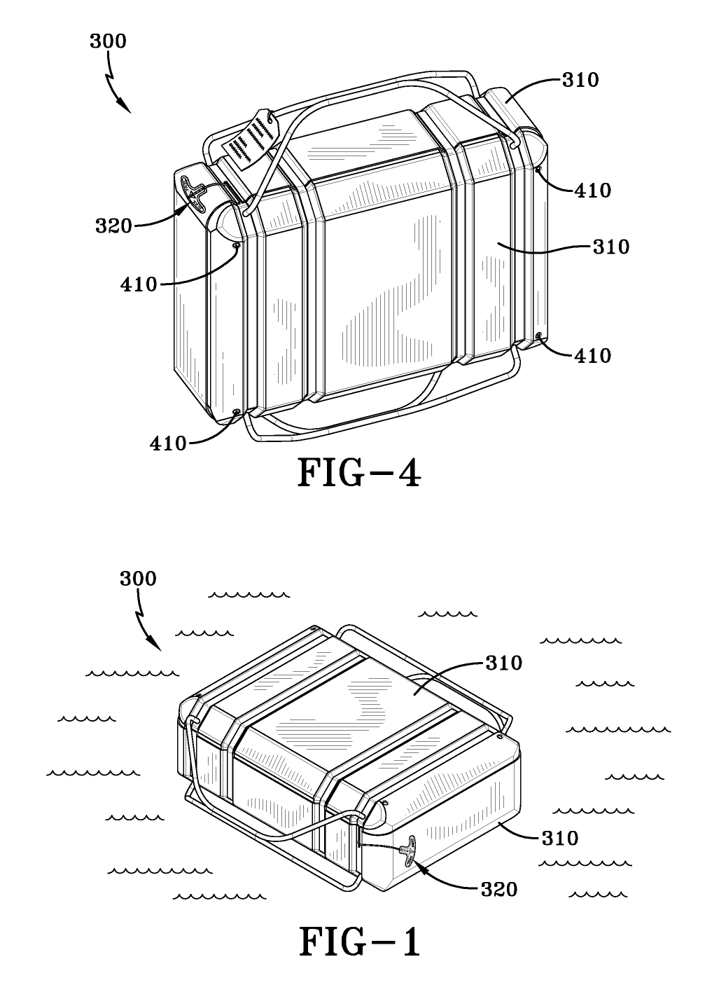

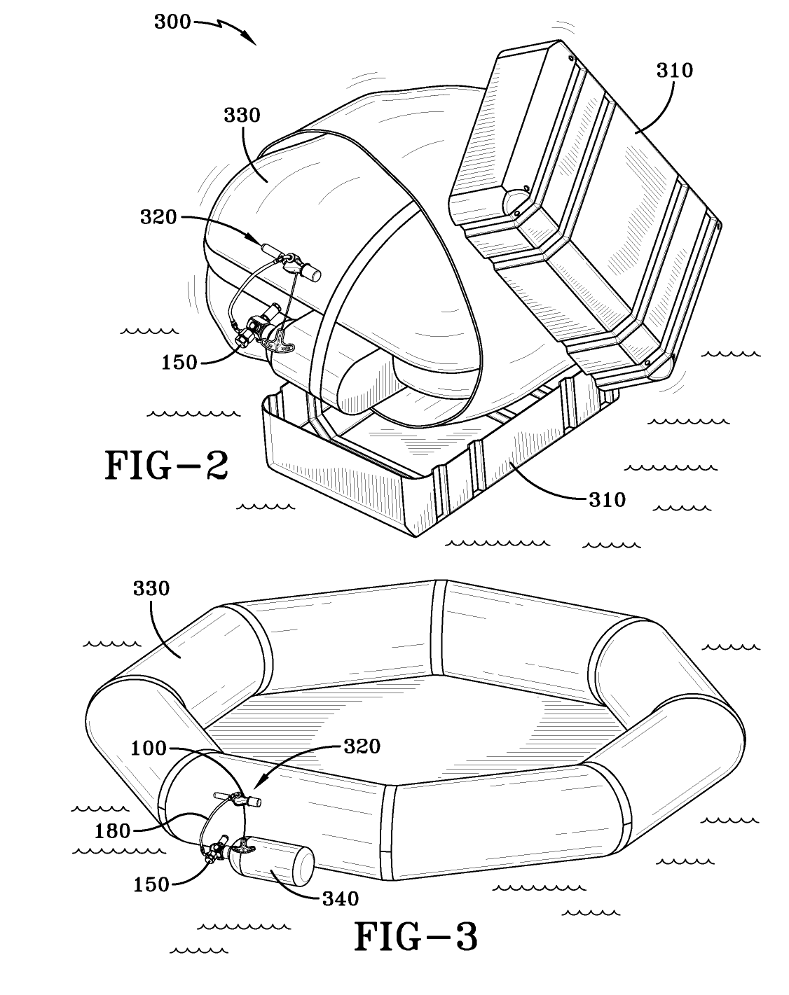

FIG. 1 depicts an uninflated, self-inflating safety device assembly 300 of the present invention on a body of water. The assembly includes a frangible container 310, which is designed to break open due to pressure from as a safety device contained within inflates. Also visible is a portion of the manual activation assembly 320. FIG. 2 depicts the self-inflating device assembly 300 of FIG. 1 self-inflating on the body of water, as the frangible container 310 breaks open as the safety device, in this embodiment a life raft 330, inflates. Although the most common device is a life raft 330, any other inflatable may be utilized.

FIG. 3 depicts life raft 330 fully inflated on the body of water and separated from frangible container 310. Also visible is a gas source 340, which is a cylinder, that holds gas to inflate life raft 330. Gas source 340 may be any gas source and includes, but is not limited to compressed air, carbon dioxide (CO₂), nitrogen, nitrogen dioxide (NO₂) and oxygen. Also visible in FIG. 3 is a pilot valve 100, a gas-operated inflation valve 150 attached to cylinder, gas source 340, and a fluid connection 180 between pilot valve 100 and inflation valve 150.

FIG. 4 depicts the self-inflating device assembly 300 of FIG. 1 in an uninflated condition, as it may be stored on a vehicle. The self-inflating device assembly 300 is depicted on its side to expose the bottom of self-inflating device assembly 300. A water inlet hole 410 extends through the bottom of frangible container 310. In FIG. 4, the bottom of frangible container 310 includes four water inlet holes 410, but frangible container may include fewer or more water inlet holes 410, and some may be included on the sides of frangible container 310. Manual activation device 320, a pull handle, is also visible in FIG. 4.

Self-inflating device assembly 300 is constructed to float, but is designed with a center of gravity such that, when positioned on water, the bottom of container 310 is in the water. If the manual activation device 320 does not activate the inflation of the life saving device, water will seep into frangible container 310 through inlet holes 410 and will contact activation assembly 200, which activates pilot valve 100, resulting in automatic inflation of life saving device, life raft 330.

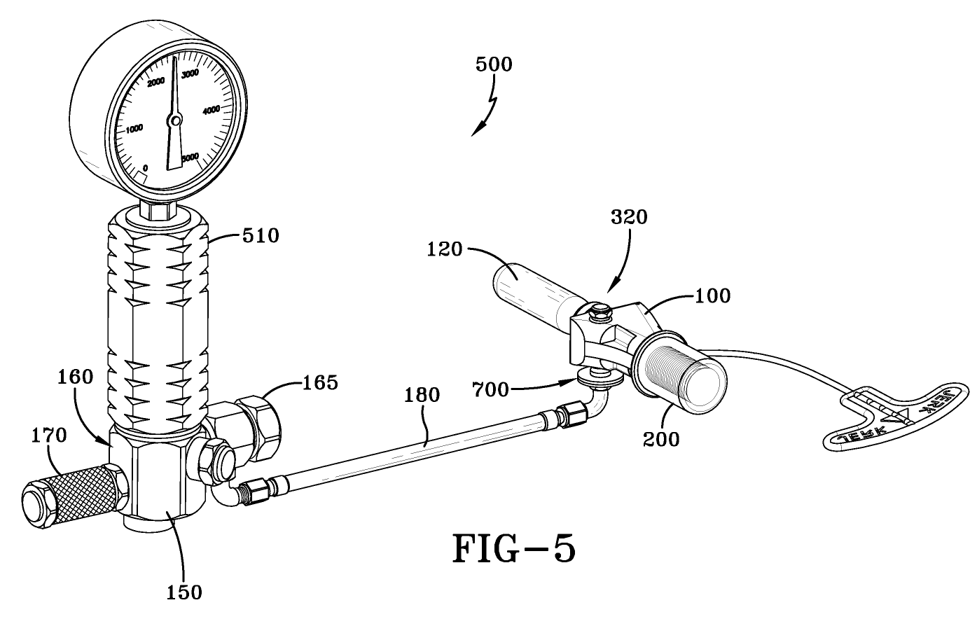

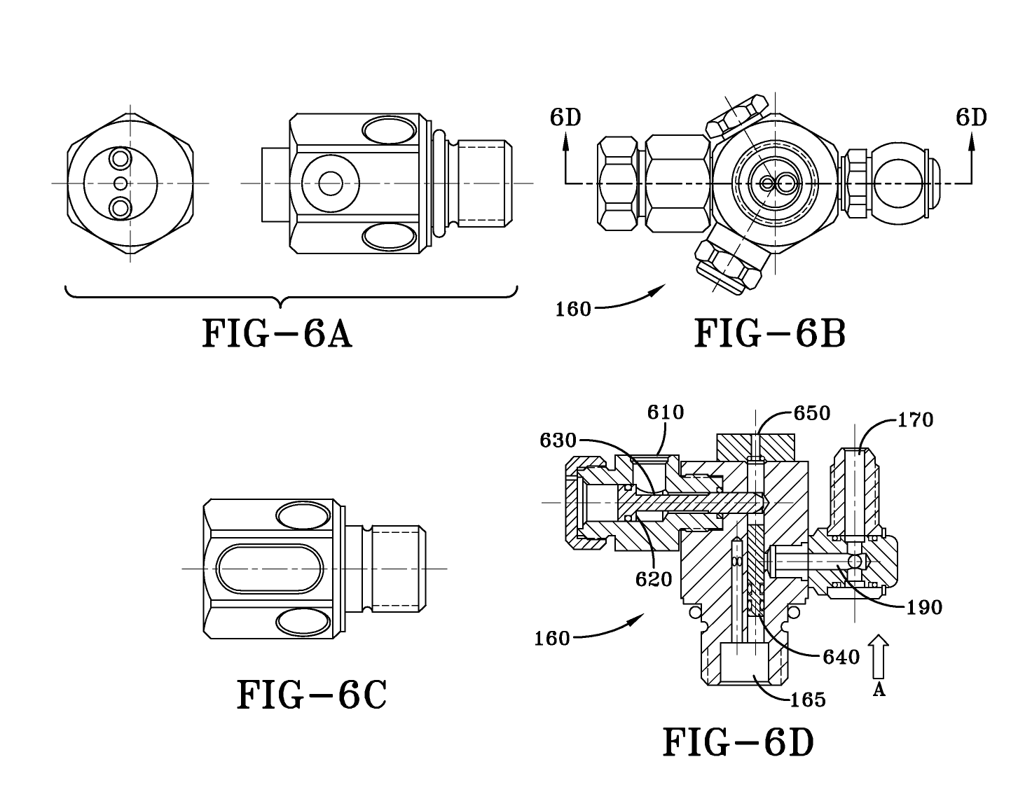

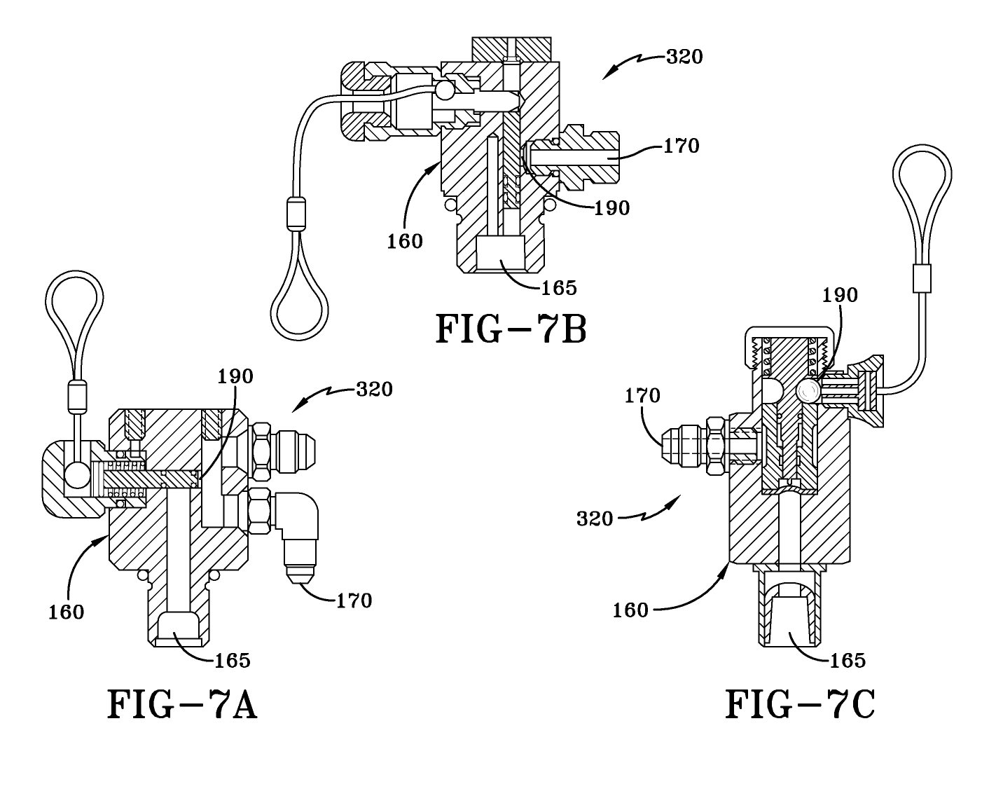

FIG. 5 depicts the inflation system 500 of the present invention. The inflation system includes a gas operated pilot valve 100 that includes a self-contained gas supply 120. In FIG. 5, self-contained gas supply 120 is a CO₂ cartridge. Pilot valve 100 includes two activation mechanisms; a manual activation assembly 320 in the form of a pull handle and a water activation assembly 200 in the form of a water valve that activates automatically when contacted with water. Such gas-operated pilot valves are commercially available from Halkey-Roberts Corporation, 2700 Halkey-Roberts Place N., St. Petersburg Fla. 33716. These gas-operated pilot valves are well-known and include a bobbin assembly designed to disintegrate when exposed to water, thereby allowing a firing mechanism to puncture the CO₂ cartridge, or alternatively, causing the CO₂ cartridge to be punctured by manual activation (i.e. pulling the handle) which penetrates a disc releasing the gas.

Pilot valve 100 is connected to gas-operated inflation valve 150 via fluid connection 180, which, in FIG. 5 is a hose connection although the connection is not restricted to a hose. Gas-operated inflation valve includes an inlet 165 and an outlet 170, and these are separated by a gas-actuated activator 160, which in FIG. 5 resides in a piston. Gas released from the gas supply 120 of the gas-operated pilot valve travels through fluid connection 180 and interacts with gas-actuated activator 160, located in the piston, moving the activator from a first position in which a passageway between the inlet 165 and the outlet 170 is blocked to a second position in which the passageway is open, as will become more apparent. FIG. 5 depicts a simulated gas source 510 rather than an actual gas source.

FIG. 6 depicts one embodiment of a gas-actuated activator 160. In this embodiment, gas from pilot valve 100 enters air squib interface 610, interacting with flange 620 on flanged pin 630 to move downward. Once pin 630 moves downward, gas pressure in the inlet (from a gas source) causes pin 640 to move to the left from its first position, in the direction of Arrow A in FIG. 6 to its second position toward safety vent 650. Safety vent 650 permits venting of gas trapped in the passageway as pin 650 moves in the direction of arrow A. This results in unblocking of passageway 190 between inlet 165 and outlet 170. When a gas source 340 is connected to inlet 165, and an inflatable safety device, such as a life raft 330, is connected to outlet 170, gas may flow from gas source to inflate raft 330.

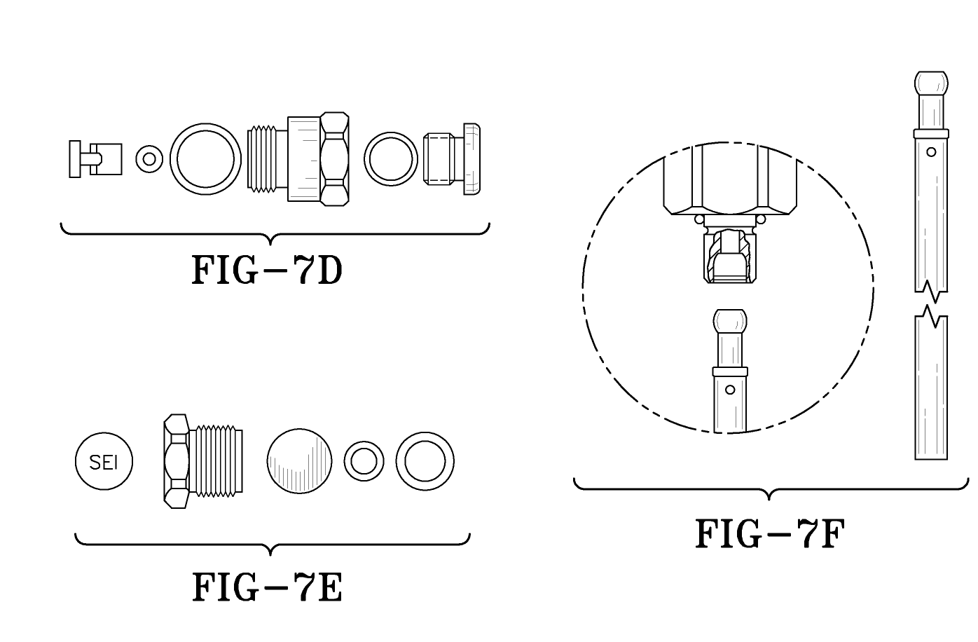

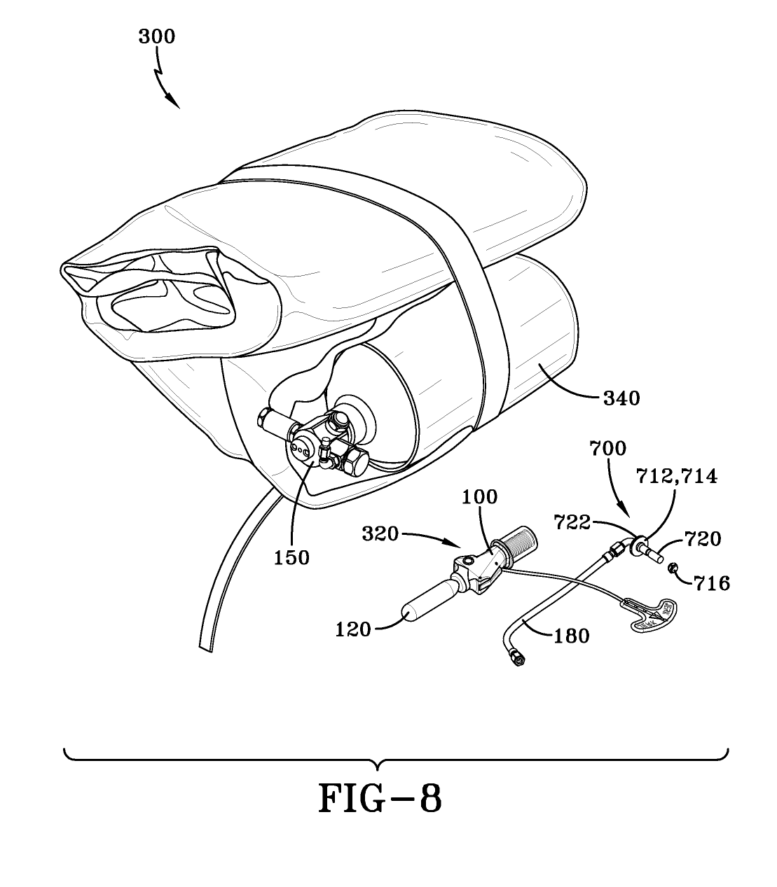

FIG. 7 depicts other embodiments of actuators 160 that may be adapted for use in the present invention. These valve options may be adapted so that the gas source activates a puncture pin, moving it from a first position to a second position, to break a frangible disk to unblock passageway 190. Alternatively, a spring mechanism may be activated by the gas source to move a restriction thereby causing the spring to bias a sealed pin in passageway 190 from a first position blocking the passageway to a second position unblocking the passageway between inlet 165 and outlet 170. Any suitable apparatus that blocks the passageway preventing flow from gas source 340 until the gas from self-contained gas supply 120 is released, thereby unblocking the passageway to provide an unobstructed channel between inlet 165 and outlet 170 may be used, so that gas can flow from gas source 340 to a safety device, such as life raft 340.

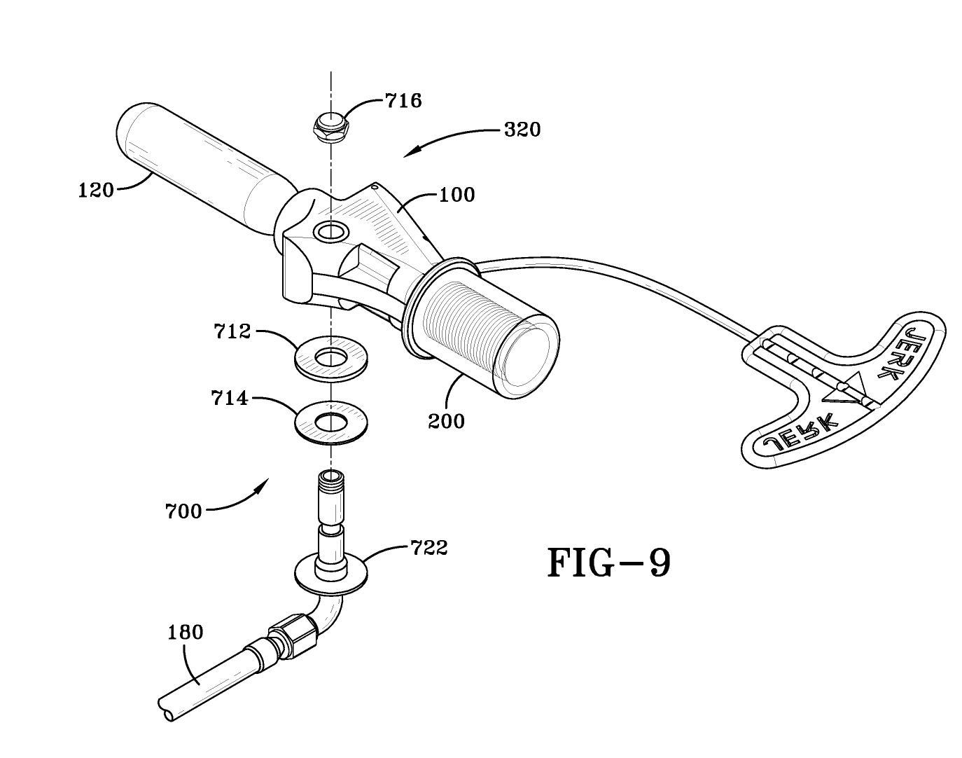

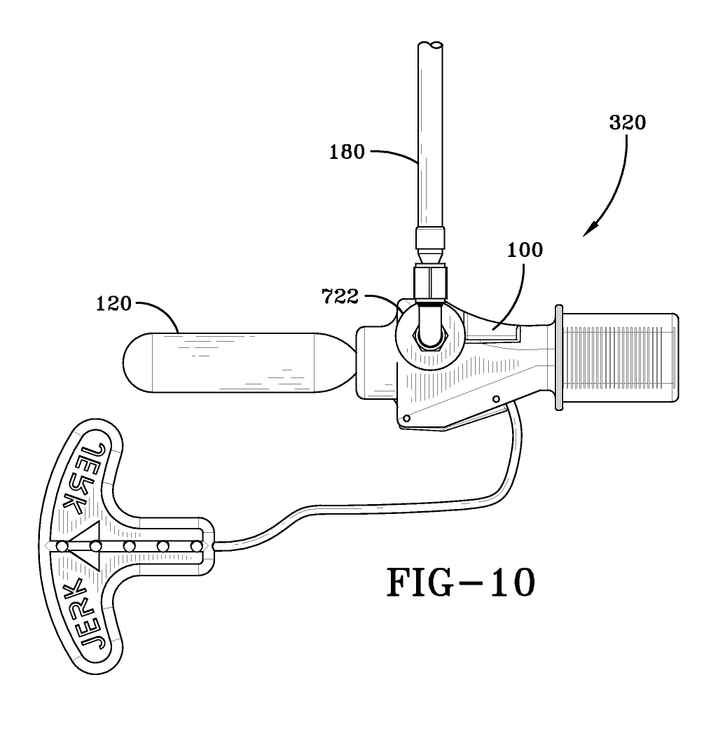

FIG. 8 and FIG. 9 in conjunction with FIG. 5 depict another novel aspect of the present invention, which is the vacuum flange assembly 700. Vacuum flange assembly 700 enables an inflatable safety device to be isolated in a protected space, here within vacuum packaging, yet allows the inflatable safety device to be activated from outside the protected space. The vacuum flange assembly permits the inflatable safety device to be protected from the environment. This system uniquely permits the vacuum flange to seal the inflatable safety device within a protected vacuum environment, which is also compressed to occupy minimal space within the vehicle in which it is carried, while only the water activated, gas-operated pilot valve is exposed to the outside environment. The vacuum seal also simplifies safety inspection of the inflatable, since any breach of the vacuum seal will allow entry of air into the vacuum bag, causing an expansion, which will be readily apparent on visual inspection.

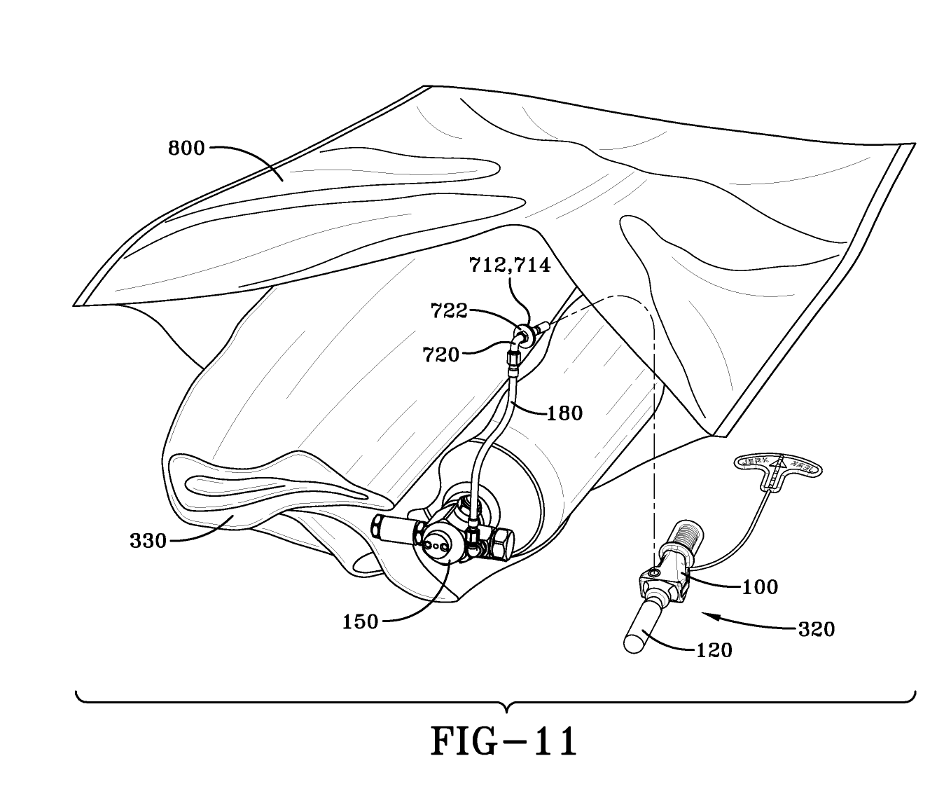

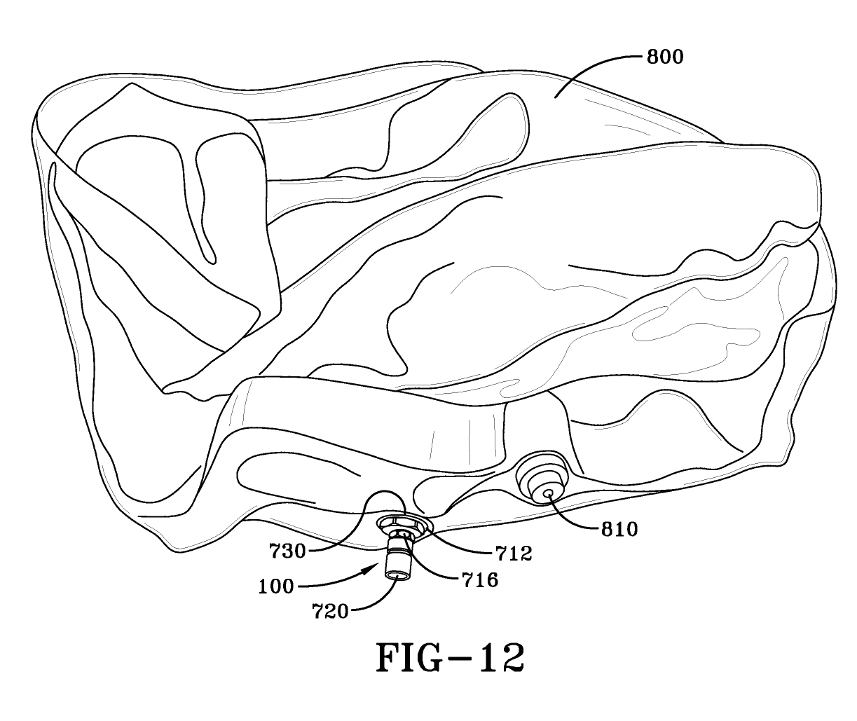

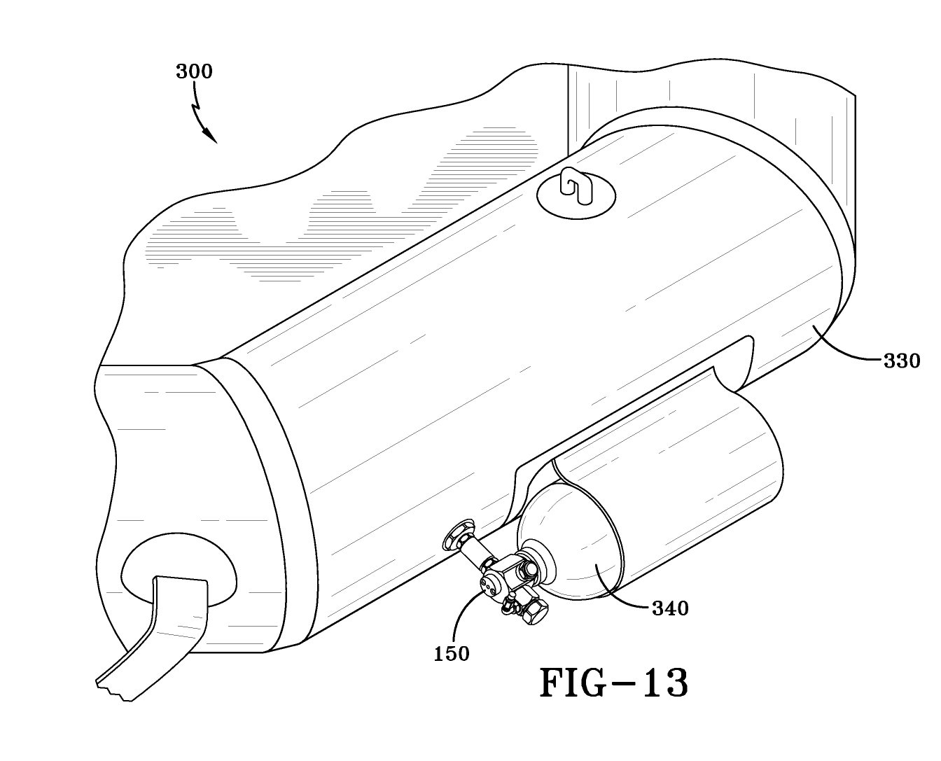

FIG. 8 is a view of a folded life raft 330 prior to being vacuum packed and sealed in a vacuum sealed package, with pilot valve components separated from gas operated inflation valve attached to a gas source 340. FIG. 9 is a detailed view of the gas-operated pilot valve with vacuum flange base and vacuum flange components. The components include a pilot valve mount 720 that has a vacuum flange base 722 attached to fluid connection 180. First and second seals, 712 and 714 fit over pilot valve mount. A vacuum bag, shown in FIGS. 11 and 12, is positioned between first and second seals, 712 and 714. Pilot valve mount 720 then slips through mounting aperture 730 and is retained in place by retainer 716. FIG. 10 shows the vacuum mounting components mounted to pilot valve 100, without a vacuum bag 800.

FIG. 11 depicts the vacuum flange components ready for assembly to a vacuum bag. Vacuum flange components are assembled to gas-operated inflation valve 150. Pilot valve mount 720 is attached to fluid connection 180 and second seal 714 is assembled over mount 720 to vacuum flange 722. These components are partially inserted into vacuum bag 800. Pilot valve 100 and the remaining vacuum flange components are ready for assembly from the outside of vacuum bag to vacuum flange 722 and secured to mount 720.

FIG. 12 is a view of the vacuum packed inflatable packaged in a vacuum bag with the pilot valve mount extending from the vacuum bag. In this view, the inflatable life raft 330 has been sealed into vacuum bag 800 Pilot valve mount 720 has been forced through vacuum bag into mounting aperture 730 so that vacuum bag 800 is captured between second seal 714 located on the inside of the vacuum bag and no longer visible, and first seal 712, visible on the outside of vacuum bag 100. Retainer cap 716 is attached over pilot valve mount 720 and tightened so that vacuum bag 800 is firmly captured between first and second seals 712, 716 and retainer cap 716 is secured to pilot valve mount 720 and extends outside of vacuum bag along with the activation mechanism 200 of the pilot valve 100, which is not visible as it is at right angles to pilot valve mount 720. A vacuum is drawn through vacuum port 810. The vacuum is drawn as the last step of the operation. The sealed inflatable is now ready for installation into frangible container 310.

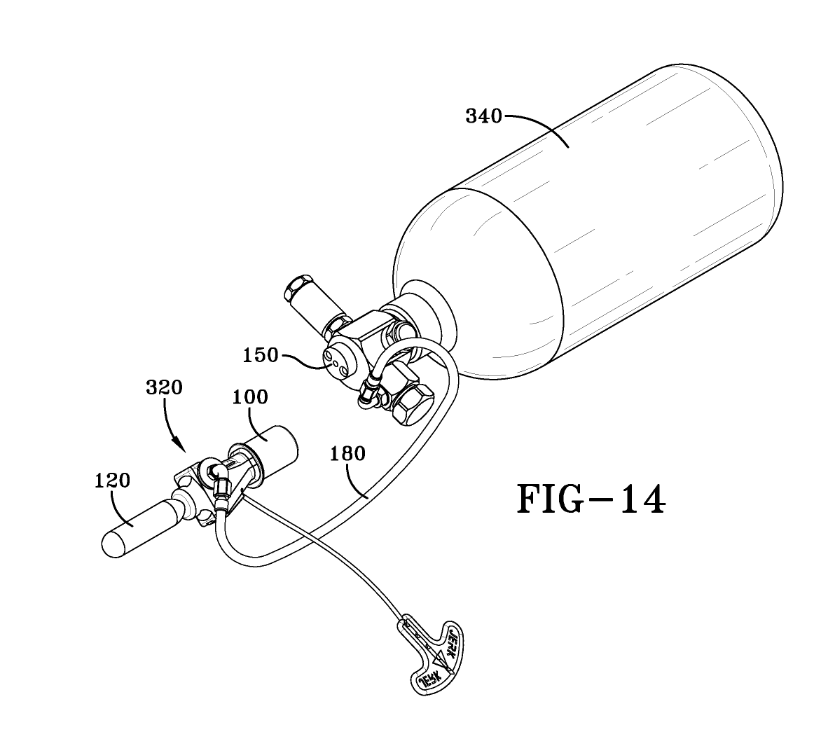

FIG. 13 is a view of a fully inflated life raft with an attached gas source 340 in a container and gas operated inflation valve 150 extending from the gas source container.

FIG. 14 is a perspective view of the inflation system of the present invention attached to a gas source 340.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An inflation system comprising:
a gas-operated pilot valve, the gas operated pilot valve included a self-contained gas supply;
a gas operated inflation valve, the gas-activated operated inflation valve including:
an inlet,
an outlet, and
a gas-activated actuator movable from a first position to
a second position;
a fluid connection between the gas-operated pilot valve and the gas-activated actuator;
an activation mechanism; and
wherein the activation mechanism in response to an activation event releases the self-contained gas supply in the gas-operated pilot valve into the fluid connection and moving the gas-activated actuator from the first position to the second position.
